(19) United States
(12) Patent Application Publication
(10) Pub. No.: US 2006/0088628 A1
(43) Pub. Date: Apr. 27, 2006

(54) Food bar

(75) Inventors: Rob R. Dekker, JV Delfgauw (NL); Erica Lynn Lamar, Cordova, TN (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Slim-Fast Foods Company, Division of Conopco, Inc.

(21) Appl. No.: 10/973,626

(22) Filed: Oct. 26, 2004

(51) Int. Cl. A23L 1/30

(52) U.S. Cl. 426/72

(57) ABSTRACT

A savory bar with good organoleptic properties. In one embodiment, the bar includes a binder comprising i) at least 40 wt. % or higher of solids, based on total solids in the binder, of one or more fibrous ingredient and ii) at least 1 wt. % of a compound which includes glycerol and/or fatty acid moieties. The food bar according the invention may include, for example, from 0.5 to 40 wt. % of the binder. In a preferred embodiment, the fibrous compound comprises dextrin, most preferably wheat dextrin. The amount of sugar solids present in the overall bar is typically limited to no greater than 10 wt. % sugar solids, especially no greater than 5 wt. %. In accordance with another embodiment of the invention, the savory food bar comprises a binder including one or more fibrous ingredients having fewer than 70% glucosidic 1,4 linkages, more than 15% glucosidic 1,6 linkages, especially from 25% to 50%, at least 5% each of glucosidic 1,2 linkages and glucosidic 1,3 linkages and the binder including no greater than 5 wt. % mono- and disaccharide solids. The invention is also directed to the binder and to processes of preparing the binder and the food bars.

### BACKGROUND OF THE INVENTION

The popularity of nutrition bars and other food bars has grown rapidly in recent years. Nutrition bars are convenient vehicles for replacement of a meal and for snacks intended to boost energy. Particularly as a meal replacements, nutrition bars may be used by those seeking to lose weight.

While consumers express a preference for snacks and other foods which are more healthful and which can assist them to achieve their weight loss and other health objectives, they show little inclination to sacrifice the organoleptic properties of their favorite foods or snacks. Therefore, it is important that food bars be palatable to consumers.

Thus far, commercial food bars have tended to be sweet. In part, this reflects the use of binding agents which are often relatively high in sugars. However, not all consumers prefer the taste of bars which provide an overall impact of sweetness. Moreover, it is believed that many consumers wish to avoid foods having high sugar levels and prefer complex carbohydrates or other macronutrients to avoid sudden elevations in blood sugar. The prevalence of binding agents with substantial amounts of sugar has tended to lead frustrate these objectives.

The patent and product literatures contain many mentions of food bars and binders therefor.

As accessed on the www.nutraceuticalsnow.com/issues/back/2002 spring/nutriose.php website on Oct. 18, 2004, Nutriose® FB, available from Roquette Freres of Lestrem, France is said to be a dextrin which is both well tolerated and stable under all acid and heat conditions encountered in food processes. The high tolerance is said to have been demonstrated in a clinical study. It is said to have no sweetness, no aftertaste. Examples of uses given are in drinks, confectionery biscuits, bars, dairy products, pastries and fruit preparations.

Nutriose® FB Technical Bulletin from Roquette America, Inc. indicates that Nutriose® FB is made by dextrinization of wheat starch and that it contains 41% of glucosidic 1,4 linkages, 32% of glucosidic 1,6 linkages, 13% of glucosidic 1,2 linkages and 14% of glucosidic 1,3 linkages. It is recommended as, among other things, a sugar free bulking agent and/or binder. Nutriose® FB is said to be an ideal component for nutrition bars and cereal bars. It is said that Nutriose® FB is especially ideal in the production of no-sugar added or low sugar products. The many listed products also include vegetarian meat substitutes and soups. Nutriose® FB is disclosed to contain less than 0.5% mono- and disaccharides. Synergy with intense sweeteners and low glycemic index are among performance characteristics said to make Nutriose® FB particularly suited for use in nutrition and cereal bars. Nutriose® FB is said to have a glycemic index of 25%.

The website at http://www.mojobar.com/honey.html, accessed on Oct. 20, 2004 discloses the Mojo Bar of Cliff Bar, Inc. The ingredients listed for the honey roasted peanut bar are honey roasted peanuts (peanuts, evaporated cane juice, honey, salt, natural flavor, natural vitamin E, organic brown rice syrup, organic pretzels (organic wheat flour, salt, organic malt syrup, organic canola oil, yeast, baking soda), soy rice crisps (rice flour, rice bran, raisin juice concentrate, honey, salt) organic peanut butter, organic dry roasted soy beans, organic oat syrup, organic honey, organic tapioca starch, crisp rice (rice flour, rice bran, rosemary extract [natural antioxidant]), rice flour, organic sunflower seed oil, sea salt, natural vitamin E (antioxidant).

Fouache et al. U.S. Pat. No. 6,630,586 (Roquette Freres) discloses branched maltodextrins having between 22% and 35% glucosidic 1-6 linkages. The content of glucosidic linkages of 1-6 between 22 and 35% is said to give the branched maltodextrins a character of indigestibility. Certain compounds of the invention are said to be able to play the role of texturizing agents, thickening and/or gelling agents, filling or encapsulating agents, particularly in food products, in pharmaceutical or veterinary products. Acariogenic compositions are disclosed which comprise maltodextrins and polyols which can be glycerine, threitol, erythritol, xylitol, arabitol, ribitol, sorbitol, mannitol, maltitol, maltotriitol, maltotetraitol, lactitol, hydrogenated isomaltulose, and hydrogented starch. The acariogenic composition comprises between 30 and 70 wt. % branched maltodexrins and between 70 and 30% by weight maltitol. Various foodstuffs such as confectionery, pastes to be chewed, preparations based on milk, yoghurts and cakes are mentioned.

According to its abstract, Serpeloni WO 2004/043166 is directed to use of branched chain maltodextrins having between 15 and 35% of 1-6 glucoside bonds as granulation binders.

Jones U.S. Pat. No. 6,749,886 (Nellson Northern Operating Inc.) is directed to a confectionery bar providing a meal replacement which has a weight ratio of proteinaceous material and a carbohydrate material higher than 1. The bar also comprises carbohydrate material selected from the group consisting of digestible carbohydrate, poorly digestible carbohydrate, non-digestible carbohydrate and mixtures thereof. The carbohydrate material is generally added as a concentrated solution. Examples include polydextrose, honey and high fructose corn syrup. Glycerol may be included. In example 1 a liquid blend including per 1000kg 453kg of polydextrose.

Kemeny patent application publication US 2003/0087004 is directed to sweet and savory ready to eat food bars. A bar containing oat bran, soy protein isolate and canola oil is disclosed.

Funk et al. US published patent application 20040013771 is directed to a layered cereal bar. The binder may be a complex carbohydrate binder made from soy protein, fat, sweeteners, water and gelatin. Syrup is also mentioned. “Conventional maltodextrin/fat based binders” are mentioned, as well. The sugar solution may be comprised of wet ingredients such as sugars and minor ingredients such as calcium, sorbitol, maltodextrin and salt. In one embodiment about 0.5% water is added to the sugar solution. Various flours can be included in the product. In one embodiment, the carbohydrates of the bar can comprise about 3 to 4% dietary fiber. In another, the total fiber percentage is about 5 to 10%. In one step of the binder preparation, soy protein is stirred in with a pre-heated shortening or fat. In a separate step, syrups, glycerin and sugars can be combined to form a sugar solution in a heated mixing kettle.

Wu EP 861 603 is directed to a process for coating a snack product with a heat-sensitive material and the product thereof. For savory hand held snack items, gums are said to be preferred viscosity increasing agents. Examples of hand held snack items given are granola bars, breakfast bars and cereal bars.

Wurtman et al. US patent application publication No: US 2003/0039739 is directed to a protein-free snack foodstuff having two or more rapidly digestible carbohydrates such as maltodextrin, dextrose and starch for weight loss. One of several product forms mentioned are food bars. Fiber, which may be insoluble or soluble, such as methylcellulose, psyllium and bran from oats, corn, rice, barley, buckwheat, and/or wheat may be included. Numerous other sources of carbohydrate, including dextrin, are listed. Savory flavors can be included.

Prosise WO 01/78522 (Procter & Gamble) discloses nutritional foods said to have a balance of amino acids, fats and carbohydrates. Fiber may be included as well. Various bar products, such as a cheese-filled bar, are disclosed.

Miller et al. U.S. Pat. No. 5,356,643 is directed to cheese filled snack bars.

Bell WO 2004/017742 (New Zealand Dairy Board) is directed to food products which may include nutrition bars. Savory flavors may be used.

Scott EP 654 223 (Unilever) discloses a hand held snack which may include particulate material such as meats of mammals, fish and poultry, and a carbohydrate binder such as various flours, gums, glucose syrup, modified starches such as Zorbit. (gels, thickeners, stabilized protein and mixtures thereof. Zorbit is believed to be a maltodextrin. The product can take the form of a snack bar.

Coleman et al. US 2004/0126477 discloses a cereal bar having a binder which includes, eg., glycerine or soribitol alone or in combination with a carbohydrate based binder such as corn syrup, corn syrup solids, molasses, honey, and the like. Suitable sweeteners which can be added include maltodextrin. Dextrin is mentioned in a discussion of a feature of the invention wherein the consumer can specify that all ingredients of a certain type, such as corn-containing ingredients, should be avoided.

Kealey et al. U.S. Pat. Nos. 6,599,553 and 6,558,713 disclose in example 18 an energy bar with maltodextrin.

Froseth et al. U.S. Pat. No. 6,592,915 is directed to a layered cereal bar. Savory flavors may be included. In one embodiment, the binder comprises, corn syrups, glycerin, sugars, (i.e., fructose, sucrose, etc.), as well as minor ingredients such as calcium, sorbitol, maltodextrin and salt.

Froseth et al. US 2002/0004749 discloses a system for selecting, ordering and distributing customized food products. Several types of customized food products are mentioned, such as “power bars.” Savory flavorings are mentioned as are maltodextrins, mentioned among carbohydrates.

Andersson WO 2004/004481 (Sudnif) is directed to a soft frozen product which may be produced as bars, balls or biscuits. Maltodextrin is mentioned as a possible stabilizer. It is said that although the products of the invention are generally sweet, savory products may be produced.

Although there have been many previous efforts to formulate nutrition and other food bars, it is desirable to attain a good tasting savory bar so that consumers will be able to turn to a tasty bar which does not present an overall sweet taste.

### SUMMARY OF THE INVENTION

Applicants have discovered a savory bar with good organoleptic properties. It does not present an overall sweet impression. In one embodiment, the bar includes a binder comprising i) at least 40 wt. % or higher of solids, based on total solids in the binder, of one or more fibrous ingredient and ii) at least 1 wt. % of a compound which includes glycerol and/or fatty acid moieties. The food bar according the invention may include, for example, from 0.5 to 50, especially 5 to 40, wt. % of the binder. In a preferred embodiment, the fibrous compound comprises dextrin, most preferably wheat or corn dextrin. Preferably, the dextrin provides at least 40 wt. % or higher of solids, based on total solids in the binder. The amount of sugar solids present in the overall bar is typically limited to no greater than 10%, especially no greater than 5 wt. % sugar solids.

In accordance with another embodiment of the invention, the savory food bar comprises a binder including one or more fibrous ingredients having fewer than 70% glucosidic 1,4 linkages, more than 15% glucosidic 1,6 linkages, especially from 25% to 50%, at least 5% each of glucosidic 1,2 linkages and glucosidic 1,3 linkages and less than 5 wt. % mono- and disaccharide solids in the binder. Preferably the food bar comprises from 0.5 to 40 wt. % of the binder.

In accordance with another aspect of the invention, the invention is directed to a savory food bar comprising one or more fibrous ingredients having fewer than 70% glucosidic 1,4 linkages, more than 15% glucosidic 1,6 linkages, especially from 25% to 50% ,at least 5% each of glucosidic 1,2 linkages and glucosidic 1,3 linkages, the bar having no greater than 10 wt. % mono- and disaccharide solids.

In accordance with yet another aspect of the invention, the invention is directed to a process of making a food bar comprising: preparing a binder including i) at least 40 wt. % or higher of solids, based on total solids in the binder, of one or more fibrous ingredient and ii) at least 1 wt. % of a compound which includes glycerol and/or fatty acid moieties, by mixing together water, the fibrous ingredient and the glycerol and or fatty acid moieties and mixing the binder with further food bar components. In a still more preferred embodiment, some or all of the water is evaporated after mixing the binder ingredients and prior to mixing the binder with the further food components. The invention is also directed to a process of preparing a binder including i) at least 40 wt. % or higher of solids, based on total solids in the binder, of one or more fibrous ingredient and ii) at least 1 wt. % of a compound which includes glycerol and/or fatty acid moieties, by mixing together water, the fibrous ingredient and the glycerol and or fatty acid moieties.

In accordance with another aspect of the invention, the invention is directed to a binding agent or binder which can be used for savory applications. In one embodiment, the binder agent comprises i) at least 40 wt. % or higher of solids, based on total solids in the binder, of one or more fibrous ingredient and ii) at least 1 wt. % of a compound which includes glycerol and/or fatty acid moieties. In a preferred embodiment, the fibrous compound comprises dextrin, most preferably wheat or corn dextrin. Preferably, the dextrin provides at least 40 wt. % or higher of solids, based on total solids in the binder agent. The amount of sugar solids present in the binder is typically limited to no greater than 5 wt. % sugar solids especially from 0.05 to 5%, preferably from 0.2 to 2%.

In accordance with another embodiment of the invention, the binder comprises a one or more fibrous ingredients having fewer than 70% glucosidic 1,4 linkages, more than 15% glucosidic 1,6 linkages, especially from 25% to 50%, at least 5% each of glucosidic 1,2 linkages and glucosidic 1,3 linkages and less than 5 wt. % mono- and disaccharide solids. The amount of sugar solids present in the binder is typically limited to no greater than 2 wt. % sugar solids. In accordance with yet another aspect of the invention, the binder includes a hydrocolloid such as a gelatin or a pectin, which can be added to the binder slurry. Typically at higher moisture levels addition of the hydrocolloid improves the binding capacity of the binder significantly, permitting preparation of bars with less dry texture.

Preferably the one or more fibrous compounds used in the binders according to the invention each has a glycemic index of less than 60%.

Although the caloric balance depends in part on the intended use of the bar, in general, the bars of the invention will have from 10 to 44% calories from fat, from 30 to 60% calories from carbohydrates and from 15 to 35% calories from protein, based on the total calories in the product. It is also preferred that the food bars of the invention comprising from 0 to 15%, especially 0.5 to 15%, calories from sugars, based on total calories in the product. Preferred food bars according to comprise essentially no artificial sweeteners.

By bars herein we refer to somewhat elongated foodstuffs which retain their shape when held at one end at room temperature. We exclude frozen products which lose their shape at room temperature.

As used herein, “sugar solids” refers to solids contributed by mono- and disaccharides.

For a more complete understanding of the above and other features and advantages of the invention, reference should be made to the following description of the preferred embodiments

### DETAILED DESCRIPTION OF THE INVENTION

One component of the binder according to the present invention is preferably added as a fiber, particularly an at least partially digestible fiber such as dextrin. It is preferred that the fibrous component of the binder is stable to typical food processing conditions, e.g., it does not hydrolyze to a substantial degree to increase the sugar content, and therefore, the sweetness, of the binder and ultimately of the product. Indeed, even when combined with glycerine which has a sweet taste, in the binder, sweetness has not been detected. Preferably, the fibrous component(s) of the binder is well tolerated by the human digestive system and has a low viscosity and is water-soluble. The low viscosity and its water solubility facilitate processing in manufacture of the food bars. Fibers are useful in that they may also have favorable effects on blood sugar and on beneficial microorganisms in the intestines. Nutriose® FB, available from Roquette Freres of Lestrem, France, is a preferred dextrin.

Fibers which are suitable for the present invention preferably include fewer than 70% glucosidic 1,4 linkages, especially from 20% to 60%, and more than 15% glucosidic 1,6 linkages, especially from 25% to 50%. Preferably, the fibrous component includes at least 5% each of glucosidic 1,2 linkages and glucosidic 1,3 linkages, especially from 10% to 30%.

Wheat is the preferred fiber source. The fiber is preferably water soluble.

Ideally, the binder of the invention includes few or no mono- and disacchardes. It is especially preferred that the binder include less than 5 wt. % mono- and disaccharides, particularly less than 2 wt. % mono- and disaccharides and most preferably less than 0.5 wt. % mono- and disaccharides.

The fiber is typically combined with water to solubilize it and the mixture is further combined with a compound which is glycerol or which includes a glycerol moiety a triglyceride. After the components have been combined to form the binder, all or a portion of the water may be boiled off, as required. The binder will typically comprise at least 40 wt. % solids of the fiber, from 1 to 40 wt. % of glycerol or the glycerol-moiety containing compound, from 0 to 50% water and from 0.1 to 10% minor ingredients such as salt and/or flour. More preferably, the binder comprises from 40-80 wt. % fiber solids, from 3 to 12 wt. % glycerol or the glycerol-moiety containing compound, from 20 to 50 wt. % water and 0.5 to 2 wt. % minor ingredients. Most preferably, the binder includes from 45-55 wt. % fiber solids, from 30 to 40 wt. % water and from 0.5 to 1 wt. % minor ingredients. Preferably, the glycemic index is less than 60%, especially less than 35%.

The binder may include a hydrocolloid such as a gelatin or a pectin, which can be added to the binder slurry. Typically at higher moisture levels addition of the hydrocolloid improves the binding capacity of the binder significantly, permitting preparation of bars with less dry texture.

When gelatin is used as a hydrocolloid in the binder, it is preferably employed at from 60 to 250 bloom strength. It may first be dissolved in water, e.g., at a temperature of about 60° C. 1 part of gelatin is preferably dissolved in not less than 2 parts of water and especially 3 or more parts of water. The gelatin solution is added to the binder preferably at a temperature between 40 and 80° C. If water is to be removed from the binder, preferably this occurs before gelatin addition. Gelatin may be present in the binder at from 0.5 to 5 wt. %, especially 1-2%. Preferably, care is taken to ensure that the water activity in the final bar does not exceed the ranges mentioned elsewhere herein.

Where pectin is used as the hydrocolloid,, preferably Low Methoxy Pectin is employed.

LM Pectin requires Calcium-ions for full functionality. (amount: 0.05-0.25%). High Methoxy Pectins are not preferred since they form gels in combination with sugar and acids. Since in this patent application, sugar is kept at the lowest possible level, HM Pectins are considered less suitable. Pectin should be predissolved in water and brought to the boil to solubilize it sufficiently. Then the pectin solution can be added to the binder (preferably at a temperature of at least 70° C. to prevent pregelling of the pectin). If required, extra water can be boiled off from the binder/pectin mixture. The pectin content in the binder can range form 0.2-3%.

The food bars of the invention may include triglycerides having unsaturated fatty acid moieties as a component of the binder and/or elsewhere in the bar. Among these may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, cottonseed oil, peanut oil, evening primrose oil, borage oil, and blackcurrant oil.

The food of the invention may include various other oils or fats as part of the binder or elsewhere within the bar. In addition to those mentioned above, such oils and fats include other vegetable fat, such as for example, cocoa butter, illipe, shea, palm, palm kernal, sal, soybean, safflower, cottonseed, coconut, rapeseed, canola, corn and sunflower oils, or mixtures thereof. A blend of oils (e.g., canola, soybean, or high oleic oils) may be used, especially containing either synthetic antioxidants such as BHT, TBHQ or natural antioxidants such as mixed tocopherols, ascorbic acid and rosemary extract or a blend of the above. When the source is for linoleic and linolenic acids (C18:2 and C18:3), straight oil or blends of oil such as canola plus soybean with an appropriate antioxidant system can be used. However, animal fats such as butter fat may also be used if consistent with the desired nutritional profile of the product.

If desired, the food bars of the invention may omega-3 and/or omega-6 fatty acids. Among those which may be useful are included arachidonic acid, docosahexaenoic acid (DHA), eicosapentaenoic acid (EPA), linebleic acid, linolenic acid (alpha linolenic acid) and gamma-linolenic acid.

Where oils containing PUFA moieties are used, it is preferred that added antioxidants such as tocopherols, ascorbic acid and/or rosemary extract be present in the oil.

In the case of a nutrition bar, preferably the overall amount of fat, including any in the binder, is not more than 45 wt. %, especially not more than 35 wt. %, preferably from 0.5 to 10 wt. %, still preferably from 0.5 to 5 wt. %.

Preferably the food bar of the invention has a water activity of 0.75 or less, preferably 0.65 or less, especially 0.6 or less.

The food bar of the invention may include protein sources. Preferred sources of protein include sources of whey protein such as whey protein isolate and whey protein concentrate, sources of rice protein such as rice flour and rice protein concentrate, and sources of pea protein. Soy protein may also be used. The protein may be present in the food in discrete nuggets, in other forms, or both in nuggets and external to nuggets.

Additional protein sources include one or more of dairy protein source, such as whole milk, skim milk, buttermilk, condensed milk, evaporated milk, milk solids non-fat, etc. The dairy source may contribute dairy fat and/or non-fat milk solids such as lactose and milk proteins, e.g. the whey proteins and caseins. Especially preferred, to minimize the caloric impact, is the addition of protein as such rather than as one component of a food ingredient such as whole milk. Preferred in this respect are protein concentrates such as one or more of whey protein concentrate as mentioned above, milk protein concentrate, caseinates such as sodium and/or calcium caseinate, isolated soy protein and soy protein concentrate. Total protein levels within the food bars of the invention are preferably within the range of 3 wt. % to 50 wt. %, such as from 3 wt. % to 35 wt. %, especially from 3 wt. % to 20%.

When protein nuggets are employed, they typically include greater than 50 wt. % of protein selected from the group consisting of milk protein, rice protein and pea protein and mixtures thereof, especially between 51 wt. % and 99 wt. %, more preferably between 52 wt. % and 95 wt. %, most preferably 55 wt. % or above. Other ingredients which may be present in the nuggets would include one or more of other proteins, such as those listed above, include lipids, especially triglyceride fats, and carbohydrates, especially starches.

Carbohydrates can be used in the food bars of the invention at levels of from 0 to 90%, especially from 1% to 49%. As indicated above, generally the presence of sugars will be minimized or eliminated since the object is a savory bar, which is not sweet. Likewise, other sweet-tasting carbohydrates will also be minimized or eliminated. Apart from sweeteners and the fibers and the carbohydrate bulking agents mentioned below, examples of suitable carbohydrates include starches such as are contained in rice flour, flour, peanut flour, tapioca flour, tapioca starch, and whole wheat flour and mixtures thereof. The levels of carbohydrates in the nutrition bar or other bar of the invention as a whole will typically comprise from 5 wt. % to 90 wt. %, especially from 20% to 65 wt. %.

If it is desired to include a bulking agent in the food, within or external to the, a preferred bulking agent is inert polydextrose. Polydextrose may be obtained under the brand name Litesse. Other conventional bulking agents which may be used alone or in combination include maltodextrin, sugar alcohols, corn syrup solids, sugars or starches, subject to the desire to minimize sweet carbohydrates expressed above. Total bulking agent levels in the food bars, of the invention, will preferably be from about 0% to 20 wt. %, preferably 5% to 16%.

Ingredients suitable to the savory nature of the bar include all types of nuts, such as peanuts, walnuts, cashew nuts, macademia nuts, and almonds, wheat nuts, pretzels, protein crisps, such as soy crisp, seeds, e.g., sunflower seeds, rolled oats, peppers such as jalapeno peppers and bell peppers, spices such as BBQ spice, chives, peanut butter, fruit pieces, such as dried cranberry, apple, etc., vegetable pieces such as rice, chips such as tortilla chips, cracker pieces, cereal such as shredded wheat, acidulants such as malic and citric acids and leavening agents such as sodium bicarbonate.. Other ingredients, often found in non-savory bars, will typically be used judiciously, if at all. These include chocolate or compound chips or other chocolate or compound pieces, cookie and/or cookie dough pieces, such as oatmeal cookie pieces, brownie pieces, fruit jelly and honey.

Flavorings are preferably added to the food or nutrition bar in amounts that will impart a savory flavor. The flavoring may be in nuggets or or external to the nuggets in the bar or other food, provided that processing is not adversely affected. Subject to the desire to provide an overall savory impression, the flavoring may be any of the commercial flavors employed in nutrition bars or other food bars, such as varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavor variations may be obtained by combinations of the basic flavors. The nutrition bars or other foods are flavored to taste. Suitable flavorants may also include seasoning, such as salt (sodium chloride) or potassium chloride. Flavorings which mask off-tastes from vitamins and/or minerals and other ingredients are preferably included in the products of the invention. Preferably, flavorants are present at from 0.25 to 3 wt. % of the food, excluding salt or potassium chloride, which is generally present at from 0 to 1%, especially 0.1 to 0.5%.

Any nuggets and the bar may include colorants, if desired, such as caramel colorant. Colorants are generally in the food at from 0 to 2 wt. %, especially from 0.1 to 1%.

If desired, the food bars, especially the nuggets, may include processing aids such as calcium chloride.

The food bars may include emulsifying agents, typical of which are phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. Mono- and di-glycerides are preferred. The emulsifiers may be present in the bar and/or protein nuggets, at levels overall of about 0.03% to 0.3%, preferably 0.05% to 0.1%. Emulsifiers may be used in combination, as appropriate.

Among fiber sources which may be included in the foods of the invention either as binder or elsewhere, are fructose oligosaccharides (fos) such as inulin, guar gum, gum arabic, gum acacia, oat fiber, cellulose, whole grains, and mixtures thereof. The compositions preferably contain at least 2 grams of fiber per 56 g serving, especially at least 5 grams of fiber per serving. Preferably, fiber sources are present in the product at greater than 0.5 wt. % and do not exceed 6 wt. %, especially 5 wt. %. As indicated above, additional bulking agents such as maltodextrin, sugar alcohols, corn syrup solids, sugars, starches and mixtures thereof may also be used, subject to the desire to have an overall savory impression. Total bulking agent levels in the products of the invention, including fibers and other bulking agents, but excluding sweeteners will preferably be from about 0% to 20%, especially from 1 to 15 wt. %. The fiber and the bulking agent may be present in the food as a whole, e.g., the food bar, and/or in nuggets, etc. provided that processing is not impaired.

Carrageenan may be included in the bars or other food of the invention, internal or external to the capsules and nuggets, eg, as a thickening and/or stabilizing agent (0 to 2 wt. % on product, especially 0.2 to 1%). Cellulose gel and pectin are other thickeners which may be used alone or in combination, e.g., at 0 to 10 wt. %, especially from 0.5 to 2 wt. %.

To the extent that it is desired to include sweeteners in the savory bar of the invention, the sweetener may be included in any nuggets or elsewhere in the bar provided that it does not interfere with processing. Natural sources of sweetness include sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Levels of sweeteners and sugar sources preferably result in sugar solid levels of 0.1 to 15 wt. %, especially from 0.5-10 wt. % of a food bar. Mono and disaccharide solids are typically present at no greater than 10 wt. %, especially 0.1-10 wt. %, especially 0.5-5 wt. %.

It will generally be preferred that artificial sweeteners are not present since the object is a savory bar. However, if it is desired to use artificial sweeteners, these may likewise be present in a nugget and/or within the bar external to the nugget, provided that it does not interfere with processing. Any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like. The artificial sweeteners are typically used in varying amounts of about 0.005% to 1 wt. % on the bar, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%, although lesser amounts may be dictated by the desire to minimize sweetness.

Since the product of the invention is preferably a savory product wherein sweetness does not predominate, it is preferred that the product contain essentially no artificial sweeteners. “Essentially no artificial sweeteners” herein refers to that level of sweetener which does not contribute perceptible sweetness to the taste of the product. It will be recognized that this level will differ from sweetener to sweetener, particularly since certain high intensity sweeteners can impart a sensation of sweetness at very low levels.

Calcium may be present in the nutrition bars or other foods at from 0 to ¹⁰⁰% of RDA, preferably from 10 to 30% RDA, especially about 25% RDA. The calcium source is preferably dicalcium phosphate. For example, wt. % levels of dicalcium phosphate may range from 0.5 to 1.5%. In a preferred embodiment, the product is fortified with one or more vitamins and/or minerals and/or fiber sources, in addition to the calcium source. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (e.g., as Manganese Sulfate), Magnesium (e.g., as magnesium phosphate), Iron (e.g., as Ferric Orthophosphate), copper (e.g., as copper sulfate), and Zinc (as Zinc Oxide). The vitamins and minerals are preferably present at from 5 to 100% RDA, especially 5 to 50% RDA, most especially from about 15% RDA. The vitamins and/or minerals may be included within, or external to, the nuggets, provided that processing and human absorption are not impaired.

RDA as referred to herein is the Recommended Dietary Allowances 10^{th} ed., 1989, published by the National Academy of Science, National Academy Press, Washington, D.C.

Apart from the preferred process of making the binder and of making the bar according to the invention, the foods of the invention may be made by known methods. Ingredients are added to the foods at a convenient time in the processing, provided that any temperature sensitive ingredients are not exposed to temperatures which cause degradation of their components. Likewise, if protein-containing nuggets are present, the processor must be sensitive to any conditions which could cause degradation of the nugget.

The bars may be single extruded, coextruded, made by sheeting through a roller (Sollich).

Extruded nutritional or other food bars may be made by cooking a syrup containing liquid (at ambient temperature) ingredients and then mixing with dry ingredients. The mixture is then extruded onto a conveyor belt and cut with a cutter. Any nuggets, e.g., protein nuggets, are included among the dry ingredients. Any nuggets should only be added to the syrup when the syrup is at a temperature below that at which any of the nugget components degrade. Syrup ingredients may include components such as dextrin, corn syrup, glycerine (0-20 wt. % on total product, especially 0.5 to 10 wt. %), lecithin, water and soybean oil or other liquid oils. In addition to the nuggets, other dry components include grains, flours (e.g., rice or peanut), maltodextrin and milk powders.

Food and/or nutritional bars in the form of granola bars may be made by cooking the syrup, adding the dry ingredients, blending the syrup and dry ingredients in a blender, feeding the blended mix through rollers and cutting with a cutter.

The bars of the invention may be coated, if the savory nature of the bar is preserved, eg with milk chocolate or yogurt flavored coating. Chocolates with little or no milk or milk products may be considered so as to maximize the presence of chocolate antioxidants and, if and to the extent desired, to try to avoid reported neutralization of antioxidants in the chocolate by milk or its components.

Typically, excluding moisture lost during processing, the uncoated bars of the invention will be made from 30-50 wt. % syrup, especially 35-45%, and 50-70 wt. % dry ingredients, especially 55-65 wt. %. Generally, coated bars according to the invention will be made from 30-50 wt. % syrup, especially 35-45 wt. %, 40-50 wt. % dry ingredients, especially 40-45% and 0-30 wt. % coating (e.g, chocolate or compound coating), especially 5-25 wt. %, particularly 10-20 wt. % coating.

Nuggets may contain greater than 50wt. %, especially greater than 60%, more preferably greater than 70 or 80% of selected non-soy proteins selected from the group consisting of milk protein, rice protein and pea protein.

It can be expected that the benefits of the invention will be realized in various types of food bars, including various types of nutrition bars having vitamins and minerals including, without limitation, snack bars and meal replacement bars. One example would be granola bars.

### EXAMPLE 1

| Ingredient | % Wgt. |
|---|---|
| Savory Binder | 37.8% |
| Port BBQ Spice | 4.5% |
| Peanuts, Dry-Roasted | 11.0% |
| Rod God Tiny Twist Pretzels | 14.0% |
| Trisun Sunflower oil | 3.0% |
| Freeze Dried Chives | 0.30% |
| Soy crisp 80% #3191 Nuvex | 14.0% |
| AM Hulled Sunflower Seeds | 4.0% |
| Vitamin blend | 1.0% |
| Cereal, RTE, Shredd Wheat, Biscuit | 5.7% |
| Wheat Nuts | 4.0% |

Nutrients per Serving (45 g)

| Calories | 148.8 | | Fat - total | 6.4 | g |
|---|---|---|---|---|---|
| Protein | 8. | g | Saturated Fat | 0.7 | g |
| Carbohydrates | 20.6 | g | Vitamin A RE | 11.7 | mcg |
| Dietary Fiber | 6.3 | g | Vitamin C | 6.8 | mg |
| Cholesterol | 0 | mg | Sodium | 745.5 | mg |

| | | | |
|---|---|---|---|
| % Calories from fat | 33% | % Calories from carbs | 48% |

| Savory Binder | % Wgt. |
|---|---|
| Nutriose FB - Roquette | 54% |
| Distilled Water (Pure) | 36% |
| Glycerine Optim 99.7% USP DOW | 9% |
| Salt, Flour | 0.6% |

Nutrients per Serving (45 g)

| Calories | 414.5 | | Fat - total | 1.5 | g |
|---|---|---|---|---|---|
| Protein | 0.8 | g | Saturated Fat | 0 | g |
| Carbohydrates | 177.8 | g | Vitamin A RE | 0 | mcg |
| Dietary Fiber | 83.8 | g | Vitamin C | 0 | mg |
| Cholesterol | 0 | mg | Sodium | 695.7 | mg |

| | | | |
|---|---|---|---|
| % Calories from fat | 2% | % Calories from carbs | 98% |

Unless stated otherwise or required by context, the terms “fat” and “oil” are used interchangeably herein. Unless otherwise stated or required by context, percentages are by weight.

The word “comprising” is used herein as “including, but not limited to” the specified ingredients. The words “including” and “having” are used synonymously.

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A food bar comprising
a) a binder including i) at least 40 wt. % or higher of solids, based on total solids in the binder, of one or more fibrous ingredient and ii) at least 1 wt. % of a compound which includes glycerol and/or fatty acid moieties.

2. The food bar according to claim 1 wherein said compound which includes glycerol and/or fatty acid moieties is glycerol.

3. The food bar according to claim 1 wherein the fibrous compound comprises dextrin.

4. The food bar according to claim 1 comprising no greater than 10 wt. % sugar solids.

5. The food bar according to claim 1 comprising from 0.5 to 40 wt. % of said binder.

6. The food bar according to claim 1 comprising from 10 to 44% calories from fat, from 30 to ⁶⁰% calories from carbohydrates and from 15 to 35% calories from protein, based on the total calories in the product.

7. The food bar according to claim 1 comprising from 0 to 15% calories from sugars, based on total calories in the product.

8. The food bar according to claim 7 comprising essentially no artificial sweeteners.

9. The food bar according to claim 7 comprising from 0.5 to 15% of calories from sugars, based on total calories in the product.

10. The food bar according to claim 9 comprising essentially no artificial sweeteners.

11. The food bar according to claim 1 wherein dextrin provides at least 40 wt. % or higher of solids, based on total solids in the binder.

12. A savory food bar comprising a binder including one or more fibrous ingredients having fewer than 70% glucosidic 1,4 linkages, more than 15% glucosidic 1,6 linkages, at least 5% each of glucosidic 1,2 linkages and glucosidic 1,3 linkages, and said binder comprising no more than 5 wt. % mono- and disaccharide solids.

13. The savory food bar of claim 12 wherein the one or more fibrous ingredients have a glycemic index of less than 60%.

14. The food bar according to claim 12 wherein said binder includes glycerol.

15. The food bar according to claim 12 wherein the fibrous compound comprises a dextrin.

16. The food bar according to claim 12 wherein said binder includes one or more triglycerides.

17. The food bar according to claim 12 comprising from 0.5 to 40 wt. % of said binder.

18. The food bar according to claim 12 comprising from 10 to 44% calories from fat, from 30 to 60% calories from carbohydrates and from 15 to 35% calories from protein, based on the total calories in the product.

19. The food bar according to claim 12 comprising from 0 to 15% calories from sugars, based on total calories in the product.

20. The food bar according to claim 12 comprising essentially no artificial sweeteners.

21. The food bar according to claim 12 comprising from 0.5 to 15% of calories from sugars, based on total calories in the product.

22. The food bar according to claim 21 comprising essentially no artificial sweeteners.

23. The food bar according to claim 12 wherein dextrin provides at least 40 wt. % or higher of solids, based on total solids in the binder.

24. A process of making a food bar comprising:
preparing a binder including i) at least 40 wt. % or higher of solids, based on total solids in the binder, of one or more fibrous ingredient and ii) at least 1 wt. % of a compound which includes glycerol and/or fatty acid moieties by mixing together water, the fibrous ingedient and the glycerol and or fatty acid moieties and mixing the binder with further food bar components.

25. The process according to claim 24 further comprising evaporating some of the water after mixing the binder ingredients and prior to mixing the binder with the further food components.

26. A savory food bar comprising one or more fibrous ingredients having fewer than 70% glucosidic 1,4 linkages, more than 15% glucosidic 1,6 linkages, especially from 25% to 50% and at least 5% each of glucosidic 1,2 linkages and glucosidic 1,3 linkages, the bar having no more than 5 wt. % mono- and disaccharide solids.

27. The food bar according to claim 1 wherein the binder comprises one or more triglycerides.

28. The food bar according to claim 1 comprising one or more of: pretzel pieces, rice puffs, sesame seeds and sunflower seeds.

29. The food bar according to claim 1 wherein said binder further includes a hydrocolloid.

30. The food bar according to claim 29 wherein said hydrocolloid is selected from a group which includes gelatins and pectins.

31. A composition comprising
a) i) at least 40 wt. % or higher of solids, based on total solids in the composition, of one or more fibrous ingredient and ii) at least 1 wt. % of a compound which includes glycerol and/or fatty acid moieties.

32. The composition according to claim 31 wherein said compound which includes glycerol and/or fatty acid moieties is glycerol.

33. The composition according to claim 31 wherein the fibrous compound comprises dextrin.

34. The composition according to claim 31 comprising no greater than 5 wt. % sugar solids.

35. The composition according to claim 31 wherein dextrin provides at least 40 wt. % or higher of solids, based on total solids in the composition.

36. The composition according to claim 31 wherein the one or more fibrous ingredients have fewer than 70% glucosidic 1,4 linkages, more than 15% glucosidic 1,6 linkages, at least 5% each of glucosidic 1,2 linkages and glucosidic 1,3 linkages, and said composition includes less than from 0.05 to 5 wt. % mono- and disaccharide solids.

37. The composition according to claim 7 further including at least 1 wt. % of a compound which includes glycerol and/or fatty acid moieties.

38. The composition according to claim 31 which is a binder.

39. A process of preparing a composition including i) at least 40 wt. % or higher of solids, based on total solids in the composition, of one or more fibrous ingredient and ii) at least 1 wt. % of a compound which includes glycerol and/or fatty acid moieties, by mixing together water, the fibrous ingredient and the glycerol and or fatty acid moieties.

40. The process according to claim 39 further comprising evaporating some of the water after mixing the ingredients.
